(19) United States
(12) Patent Application Publication
(10) Pub. No.: US 2020/0147624 A1
(43) Pub. Date: May 14, 2020

(54) TWO-FLUID NOZZLE

(71) Applicant: SPRAYING SYSTEMS CO., JAPAN, Tokyo (JP)

(72) Inventors: Toshikazu Hamaura, Sousa-city, Chiba (JP); Hiroshi Sekiya, Tokyo (JP); Tomohiko Nagatsuka, Shizuoka (JP)

(73) Assignee: SPRAYING SYSTEMS CO., JAPAN, Tokyo (JP)

(21) Appl. No.: 16/631,072

(22) PCT Filed: Jun. 28, 2018
(86) PCT No.: PCT/JP2018/024501

§ 371 Date: Jan. 14, 2020

(30) Foreign Application Priority Data
Jul. 21, 2017 (JP) 2017-141565

(51) Int. Cl. B05B 7/06; B01F 3/04

(52) U.S. Cl. CPC B05B 7/066; B01F 3/04063

(57) ABSTRACT

A two-fluid nozzle of an internal mixing type in which clogging does not occur easily, excellent atomization performance can be obtained, and various application can be realized with simple constitution is provided.

A constitution is such that a liquid cap body having a fluid channel formed therein and into which a supply liquid is supplied from an upstream side and an air cap body provided on a downstream portion of the liquid cap body and into which a supply gas is supplied are provided, a liquid outlet is provided on a downstream end of the liquid cap body, a gas chamber portion into which the supply gas is supplied is formed inside the air cap body, a mixed gas outlet is formed on the downstream side of the gas chamber portion, and a mortar-shaped mixed-gas expanding portion is provided immediately after the mixed gas outlet.

### CROSS-REFERENCE TO RELATED APPLICATIONS

This application is the § 371 National Stage Entry of International Patent Application No. PCT/JP2018/24501, filed on Jun. 28, 2018, which claims priority to Japanese Patent Application No. 2017-141565, filed on Jul. 21, 2017.

### FIELD OF THE INVENTION

The present invention relates to a two-fluid nozzle of an internal mixing type.

### BACKGROUND OF THE INVENTION

Two-fluid nozzles include various types, and they are roughly classified into an internal mixing type and an external mixing type.

In the internal mixing type designed so that fluids can be mixed inside a nozzle, although atomization can be performed efficiently and particles can be easily obtained, a mixed-phase flow is conveyed inside the nozzle in which a mixed gas can be solidified easily, and thus the nozzle can be easily clogged and cannot be used for a long time, which is a disadvantage.

On the other hand, in the nozzle of the external mixing type, since the fluids are mixed in an atmosphere outside the nozzle, it has a merit that clogging does not occur easily. Thus, even a liquid which is easily solidified can be used, but since the liquids are mixed in the atmosphere, they are diffused, which deteriorates atomization performance and limits applications, which is a disadvantage.

This type of nozzle includes the following, for example:

Patent Literature 1: Japanese Patent Laid-Open No. 2006-82058

Patent Literature 2: Japanese Patent Laid-Open No. 2005-296874

Patent Literature 3: Japanese Patent Laid-Open No. 2009-119352

Patent Literature 4: Japanese Patent Laid-Open No. H7-171444

The nozzle in Patent Literature 1 is a nozzle with an emphasis on prevention of re-adhesion of a mist floating in the atmosphere after spraying. Since this nozzle is a type of mixing liquids inside, it was confirmed that adhesion and deposition of the liquid started during conveyance inside, and the clogging occurred in an extremely short operation time such as several hours.

The nozzle in Patent Literature 2 is a nozzle of the external mixing type in which liquids are made to collide against each other in the atmosphere so as to be atomized, and a pattern is formed.

The nozzle of this external mixing type has fluid outlets at two spots. Thus, it has a problem that extremely precise working accuracy is required for uniform spraying of a very small amount of liquids for collision in the atmosphere. Moreover, since maintenance of the nozzle is difficult, more simplified structures are in demand.

The nozzle in Patent Literature 3 is a nozzle having a structure in which a liquid which is easily solidified is circulated inside the nozzle, and a required amount of the liquid is controlled by a valve and is supplied while solidification is prevented.

This nozzle has no contact between the liquid and the gas until the spraying into the air and is capable of preventing solidification, but since atomization into the atmosphere is performed, particle size distribution becomes wider in the particle size after spraying, and an average particle size tends to be large and cannot be used for a coating application of a thin film, and further atomization is in demand, which is a problem.

The nozzle in Patent Literature 4 is a nozzle which is worked so that liquid collection does not occur in a distal end portion of a liquid spraying torrefaction nozzle, and the fluids are mixed outside of the nozzle.

This nozzle is similar to that in Patent Literature 3 in a structure of a portion where atomization is performed, when an attention is paid to the nozzle portion. Since this nozzle has a structure in which the atomization is performed in the atmosphere, the particle size distribution becomes a wide range, and it is disadvantageous in atomization, which is a problem.

### SUMMARY OF THE INVENTION

The present invention was proposed in view of the above and has an object to provide a two-fluid nozzle of an internal mixing type in which clogging does not occur easily, excellent atomization performance can be obtained, long-time use can be made, constitution is simple, and various application can be realized

In order to solve the aforementioned problem, the present invention is characterized by having a constitution including a liquid cap body having a fluid channel formed therein and into which a supply liquid is supplied from an upstream side and an air cap body provided on a downstream portion of the liquid cap body and into which a supply gas is supplied, a liquid outlet is provided on a downstream end of the liquid cap body, a gas chamber portion into which the supply gas is supplied is formed inside the air cap body, a mixed gas outlet is formed on the downstream side of the gas chamber portion, and a mortar-shaped mixed-gas expanding portion is provided on the mixed gas outlet.

According to a first aspect of the present invention, the mixed-gas expanding portion is formed immediately after the mixed gas outlet and has a bowl shape with an enlarged diameter or a dent portion on a part thereof.

According to a second aspect of the present invention, the liquid outlet is provided on an upstream side of the mixed gas outlet and in the vicinity of the mixed gas outlet.

According to a third aspect of the present invention, a diameter of the mixed gas outlet is formed larger than a diameter of the liquid outlet, a mixing portion is formed between the liquid outlet and the mixed gas outlet, and the mixed gas outlet is formed having a sectional area larger than an outlet diameter of the mixing portion.

Since the mixed-gas expanding portion provided on the mixed gas outlet is formed having a mortar shape, the mixed gas from the outlet is rapidly diffused, whereby atomization is promoted and droplets are formed which can be conveyed easily by an atomization gas, which can reduce liquid deposition on the mixed gas outlet and has an effect that clogging can be prevented.

According to the first aspect of the invention, since the mixed-gas expanding portion is provided immediately after the mixed gas outlet, the mixed gas from the outlet can be immediately diffused, whereby atomization can be promoted, and by providing the dent portion, the mixed gas can be further diffused and is rapidly discharged to an outside, which leads to an effect that the liquid deposition can be reliably reduced.

According to the second aspect of the invention, since the liquid outlet is arranged closer to the upstream side than the mixed gas outlet so that the supply liquid is blown out of the liquid outlet by a force higher than a gas pressure on the front of the liquid outlet, the supply liquid is crushed by the force of the gas immediately after the liquid outlet, and the mixed gas in a state where the atomization is promoted can be obtained.

According to the third aspect of the invention, a space between the liquid outlet of the supply liquid and the mixed gas outlet where the liquid is blown out of the liquid outlet at a maximum flow velocity is made the mixing portion, the flow of the supply liquid and the gas collide against each other from the outer peripheral side of the mixing portion toward the center thereof, whereby the atomization is promoted, the diameter of the mixed gas outlet is made larger than the diameter of the liquid outlet so that discharge is made rapidly, and the mixed gas is rapidly diffused through the mixed-gas expanding portion having a mortar shape immediately thereafter, whereby liquid deposition, solidification, and adhesion inside can be reduced, and an effect of stable use for a long time is provided.

Moreover, due to the simple constitution, manufacture is easy, and a manufacturing cost can be reduced, and maintenance can be performed easily since no deposition occurs inside the nozzle. Thus, not only is the frequency of maintenance reduced but also an effect that a work time for disassembling/cleaning of the nozzle in the maintenance is reduced can be obtained.

### BRIEF DESCRIPTION OF THE DRAWINGS

FIG. 1 is a longitudinal sectional view of an embodiment of the present invention.

FIG. 2 is an operation explanatory view of the above.

FIG. 3 is an enlarged explanatory view of a mixing portion of the above.

FIG. 4 is a longitudinal sectional view of another embodiment of the present invention.

FIG. 5 illustrates a longitudinal sectional view of still another embodiment of the present invention.

### DETAILED DESCRIPTION OF PREFERRED EMBODIMENTS

Preferred embodiments of the present invention will be described below by referring to the attached drawings but the present invention is not limited to the illustrated embodiments but encompasses various design changes within a range not departing from the spirit of the present invention.

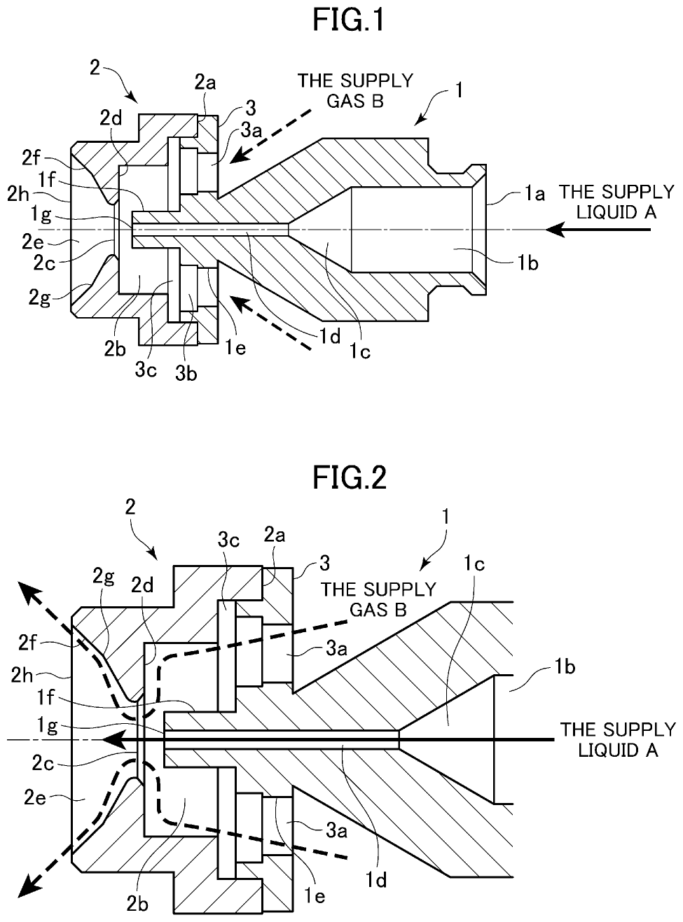

FIG. 1 illustrates an embodiment of a two-fluid nozzle of an internal mixing type according to the present invention. This two-fluid nozzle includes a liquid cap body 1 and an air cap body 2 provided on a downstream-side distal end portion of this liquid cap body 1.

The liquid cap body 1 has a hollow shape with a right side in the figure, that is, an upstream side open and forming a supply port 1a of a supply liquid A such as a mold releasing agent or an adhesive. A first fluid channel 1b which is linear in a center part axial direction and has a uniform inner diameter is formed therein, and a second fluid channel 1c having a diameter sequentially reduced toward the downstream side and a tapered shape whose section is tapered is formed on the downstream side of this first fluid channel 1b. Moreover, a third fluid channel 1d having a diameter smaller than that of the first fluid channel 1b and having a uniform inner diameter is formed on the downstream side of the second fluid channel 1c.

The air cap body 2 mounted on the distal end portion of the liquid cap body 1 on the downstream side has a gas supply portion 3 forming a substantially cylindrical shape.

The gas supply portion 3 is mounted on an inner end portion 2a of the air cap body 2, and this gas supply portion 3 is in close contact with a mounting portion 1e on an outer periphery of the downstream-side distal end of the liquid cap body 1 and is integrated by appropriate means.

A gas channel hole 3a for supplying a gas into the air cap body 2 is formed in the gas supply portion 3. Moreover, a gas straightening groove 3b is formed on the downstream side of the gas channel hole 3a, and this gas straightening groove 3b communicates with a gas chamber portion 2b formed in the air cap body 2.

A diameter of the gas straightening groove 3b is larger than that of the gas channel hole 3a.

Moreover, a gas straightening chamber 3c having a diameter larger than that of the gas straightening groove 3b is formed between the gas straightening groove 3b and the gas chamber portion 2b. This gas straightening chamber 3c plays a role of changing a flow so that the gas entering through the gas channel hole 3a is straightened by the straightening groove 3b.

At a center part in the gas chamber portion 2b, a distal end portion of a cylindrical liquid outlet outer cylinder 1f having the third liquid channel 1d inside protrudes, and a distal end opening portion of this liquid outlet outer cylinder 1f forms the liquid outlet 1g.

Moreover, the gas chamber portion 2b communicates with the mixed-gas expanding portion 2e through the mixed gas outlet 2c formed on the front.

On the gas chamber portion 2b, a wall 2d against which a supply gas B flowing in through the gas channel hole 3a collides and changes its direction by changing an angle to the liquid outlet 1g side is formed. This wall 2d protrudes toward an inner side of the air cap body 2 and has the mixed gas outlet 2c formed at a center part. The liquid outlet 1g is located on an upstream side of this mixed gas outlet 2c.

The diameter of the mixed gas outlet 2c is formed larger than the diameter of the liquid outlet 1g so that the mixed gas is discharged rapidly. Moreover, the liquid outlet 1g is located in the vicinity of the mixed gas outlet 2c.

A wall surface 2f which is an inner peripheral surface of the mixed-gas expanding portion 2e located on the front of the gas chamber portion 2b is formed having a mortar shape whose inner diameter is gradually increased from the mixed gas outlet 2c toward the downstream side of a front end.

Here, the mortar shape is a substantially conical shape in general and is assumed to include a bowl shape and a shape having the dent portion 2g formed at a part thereof. In this embodiment, the dent portion 2g is formed substantially at the center part of the mixed-gas expanding wall surface 2f. The shape is such that the inner diameter is enlarged at the portion of the dent portion 2g, from where the diameter is sequentially enlarged toward a nozzle injection port 2h.

This dent portion 2g is substantially at the center part of the mixed-gas expanding wall surface 2f in the illustrated example, but the position is not necessarily limited to this, and may be on the mixed gas outlet 2b side. Moreover, the dent portion 2g is formed having a dent shape with a gently angled shape in sectional view, but the shape is not limited to this shape.

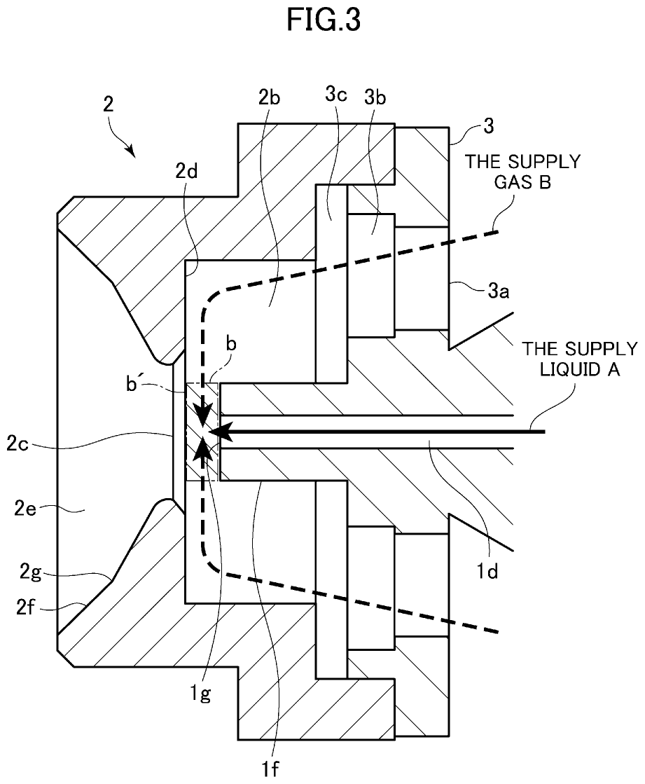

FIGS. 2 and 3 illustrate explanation of a flow of the supply liquid A (indicated by a solid line) supplied from the supply port 1a and the supply gas B (indicated by a broken line) from the gas channel hole 3a.

When the supply liquid A with a predetermined liquid pressure is supplied from the supply port 1a during operation, since the inner diameter of the second fluid channel 1c is gradually tapered and narrowed toward the inside, the flow velocity of the supply liquid A increases, and upon entry into the third fluid channel 1d, the flow velocity is accelerated.

As described above, the supply liquid A flows through the first to third fluid channels 1b to 1d and is discharged into the gas chamber portion 2b through the liquid outlet 1g, but the supply gas B for atomization is present in the gas chamber portion 2b, and by forming a flow so that the gas flowing around the liquid outlet 1g covers the liquid outlet 1g like a lid, an inner pressure can be applied to the sprayed liquid from the liquid outlet 1g. That is, in the present invention, the liquid outlet 1g is arranged closer to the upstream side than the mixed gas outlet 2b so as to form such a flow that the gas flowing in the periphery covers the liquid outlet 1g like a lid. Therefore, in order to cause the supply liquid A to be sprayed from the liquid outlet 1g, it needs to be discharged by a force higher than the pressure by the lid of the gas, and the supply liquid A is crushed by the gas immediately after the liquid outlet 1g, whereby atomization is promoted, and can obtain uniform particle distribution.

Moreover, in the present invention, location of the liquid outlet 1g in the vicinity of the mixed gas outlet 2c is also a feature in the constitution.

That is, in the prior art, the atomization gas flows in the same direction in parallel with the liquid, and the liquid is sprayed to the center part of the gas flow. Thus, in order to uniformly mix the gas and the liquid, a mixing area called a chamber portion is needed. Since the mixed gas outlet is needed after the chamber portion, the liquid deposition occurs at a spot where a change is generated in the flow.

In order to solve the aforementioned problem, by providing a structure in which the flow of the atomization gas is brought into contact with the liquid flow with an angle by the wall 2d in the present invention, the chamber portion is made smaller to such a degree that is rarely needed, and the liquid outlet 1g is arranged in the vicinity of the mixed gas outlet 2c in the constitution. At this time, by making the diameter of the mixed gas outlet 2c sufficiently larger than that of the liquid outlet 1g, discharge can be performed to the downstream side faster than solidification of the liquid, and the mixed gas can be rapidly discharged into the atmosphere from the nozzle injection port 2h.

The diameter of the mixed gas outlet 2c needs to be larger than that of an outlet b′ of the mixing portion b indicated by a hatched area in FIG. 3. Thus, in the present invention, the diameter of the mixed gas outlet 2c is preferably made 1.4 to 1.5 times of the diameter of the outlet b′ of the mixing portion b. It was confirmed by an experiment that if it is 2.5 times or more, it is too large, and atomization becomes insufficient. Moreover, in the sectional area (hatched part) of a collision portion of the mixing portion b in FIG. 3, a ratio between the vertical and the horizontal of the area is preferably approximately 1:3. In this case, an axial direction of a liquid flow is the vertical, and the diameter of b′ is the horizontal.

Moreover, in the present invention, the mixed gas after being sprayed from the liquid outlet 1g is rapidly diffused by the mixed-gas expanding portion 2e immediately after the mixed gas outlet 2c, whereby the atomization is promoted and droplets are formed which can be conveyed easily by the gas, whereby the liquid deposition on the mixed gas outlet 2c can be reduced.

In this case, a spraying direction is changed by the mixed-gas expanding portion 2e having a mortar shape provided immediately after the mixed gas outlet 2c so that the flow of the mixed gas is diffused to the outer peripheral side.

By employing the aforementioned constitution, the atomization gas is compressed the most in the gas chamber portion 2b which is a mixing portion with the liquid and is soon expanded at the mixed gas outlet 2c immediately thereafter so that the flow expanded by the mixed-gas expanding portion 2e having the mortar shape can be smoothly released into the atmosphere without being hindered, and there is no spot which hinders the gas flow and thus, the liquid which can be easily solidified can be discharged into the atmosphere through the nozzle injection port 2h before the liquid is solidified.

In the above, a spot where the gas is compressed the most is the mixing portion b with shading illustrated in FIG. 3, and the mixed gas is atomized immediately after the mixed gas outlet 2c. Since the atomized mixed gas is discharged as it is, deposition of the solidified liquid is reduced as compared with a case of the internal mixing nozzle of the prior art.

Table 1 illustrates a Sauter's mean diameter D32 and the like of a developed product nozzle of the present invention. As indicated by a bold frame on a right end portion, the mean particle diameter of the developed product is approximately 40 to 70% of that of the external mixing nozzle of the prior art, and the particle size is smaller even in a state where the gas amount is changed. That is, it shows that atomization is performed sufficiently.

TABLE 1
Comparison of atomized particle size
A result of comparison of the particle sizes between the developed
product nozzle and the external mixing nozzle of the prior art when
the same liquid amount is sprayed is as in the table.

| | | | | | DROPLET | DROPLET |
|---|---|---|---|---|---|---|
| | | | | | SIZE | SIZE |
| | | | | | VOLUME | SAUTER'S |
| | PRESSURE | FLOW RATE | FLOW RATE | PRESSURE | MEDIAN | MEAN |
| | AIR | LIQUID FLOW | AIR FLOW | LIQUID | DIAMETER | DIAMETER |
| | PRESSURE | RATE | RATE | PRESSURE | VMD Dv0.5 | SMD D32 |
| NOZZLE | [MPa] | [mL/min] | [L(normal)/min] | [MPa] | [μm] | [μm] |
| DEVELOPED | 0.02 | 5 | 13 | 0.01 | 8.51 | 4.78 |
| PRODUCT | 0.03 | | 15 | 0.015 | 7.01 | 4.24 |
| | 0.04 | | 17 | 0.02 | 5.82 | 4.06 |
| | 0.05 | 10 | 18 | 0.03 | 9.25 | 5.21 |
| | 0.07 | | 22 | 0.05 | 7.38 | 4.47 |
| | 0.1 | | 28 | 0.07 | 6.00 | 4.12 |
| EXTERNAL | 0.1 | 5 | 9 | — | 21.80 | 14.01 |
| MIXING | 0.15 | | 11 | — | 11.75 | 7.21 |
| TYPE OF | 0.25 | | 16 | — | 9.39 | 5.86 |
| PRIOR ART | 0.15 | 10 | 9 | — | 24.91 | 16.82 |
| | 0.2 | | 11 | — | 15.91 | 9.92 |
| | 0.25 | | 16 | — | 10.48 | 9.32 |

As shown by the aforementioned Table 1, atomization is sufficiently performed even in a low pressure region in the vicinity of a pressure 0.1 MPa of the air (supply gas), and due to the low pressure, the nozzle can be used for thin film coating with less splashing of a mist and reduced diffusion and has a wide range of application in various fields.

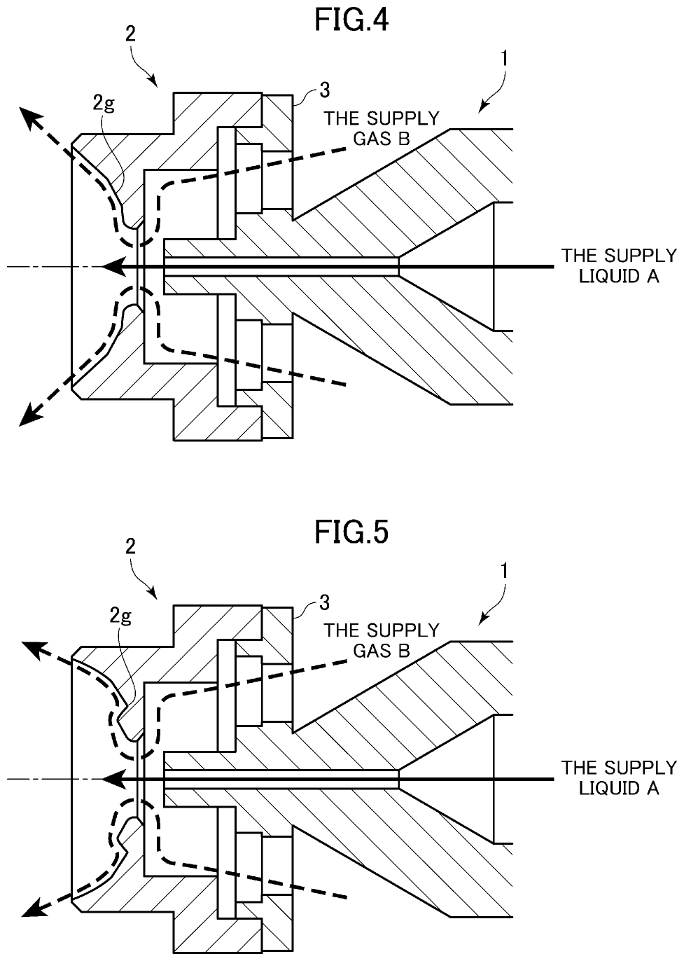

In the aforementioned embodiment, the dent portion 2g has a dent portion with a gently angled shape in sectional view, but the shape is not limited to this shape, and a tapered shape as illustrated in FIG. 4, a stepped shape as illustrated in FIG. 5, or a curved shape and other shapes, though not particularly shown, may be used. Since other configurations are similar to the aforementioned embodiment, detailed description is omitted.

### REFERENCE SIGNS LIST

1 liquid cap body
1a supply port
1b first fluid channel
1c second fluid channel
1d third fluid channel
1e mounting portion
1f liquid outlet outer cylinder
1g liquid outlet
2 air cap body
2a mounting portion
2b gas chamber portion
2c mixed gas outlet
2d wall
2e mixed-gas expanding portion
2f mixed-gas expanding wall surface
2g dent portion
2h nozzle injection port
3 gas supply portion
3a gas channel hole
3b gas straightening groove
3c gas straightening chamber

1-4. (canceled)

5. A two-fluid nozzle, comprising:
a liquid cap body having a fluid channel formed therein and into which a supply liquid is supplied from an upstream side; and
an air cap body provided on a downstream portion of the liquid cap body and into which a supply gas is supplied;
wherein:
a liquid outlet is provided on a downstream end of the liquid cap body;
a gas chamber portion into which the supply gas is supplied is formed inside the air cap body;
a mixed gas outlet is formed on a downstream side of the gas chamber portion;
the liquid outlet is provided on an upstream side of the mixed gas outlet and in a vicinity of the mixed gas outlet;
a diameter of the mixed gas outlet provided on a downstream is formed larger than a diameter of the liquid outlet;
a mixing portion is formed between the liquid outlet and the mixed gas outlet;
the mixed gas outlet is formed having a sectional area larger than an outlet diameter of the mixing portion; and
a mortar-shaped mixed-gas enlarging portion, in which a wall surface having an inner diameter gradually increased from the mixed gas outlet toward the downstream side of a front end, is provided immediately after the mixed gas outlet.

6. The two-fluid nozzle according to claim 5, wherein the mixed-gas enlarging portion has a shape having a dent portion on a part thereof.
